(19) United States
(12) Patent Application Publication
(10) Pub. No.: US 2007/0007916 A1
(43) Pub. Date: Jan. 11, 2007

(54) Voltage modulating apparatus for motor of electrical vehicle

(76) Inventor: Yen Chieh Wu, Shu-Lin City (TW)

Correspondence Address: Yi-Wen Tseng, 4331 Stevens Battle Lane, Fairfax, VA, 22033, US

(21) Appl. No.: 11/174,206

(22) Filed: Jul. 5, 2005

(51) Int. Cl. H02P 7/06

(52) U.S. Cl. 318/66

(57) ABSTRACT

A voltage modulating apparatus for a motor of an electrical vehicle includes a driver, a governor, a PWM device, a Hall sensor and an energy saver. The driver sends a driving signal to a motor of the electrical vehicle. The governor is controlled by a user to output a speed adjusting signal to the driver so that the driver can drive the motor to change a rotating speed. The PWM device is connected to the driver. The Hall sensor is installed in the motor for detecting a speed change of the motor to send a Hall signal to the PWM device. The energy saver is connected with driver for detecting a change of the driving signal to control the PWM device to send a PWM signal to the driver merely as the rotating speed of the motor is reduced. As such, a power saving effect for the motor is obtained.

### BACKGROUND OF THE INVENTION

1. Field of Invention

The present invention relates in general to a voltage modulating apparatus for a motor of an electrical vehicle, and more particular, to a motor control apparatus which merely depends on a reducing rotating speed of a motor to control a pulse width modulation (PWM) signal to increase a drive voltage of the motor.

2. Related Art

A DC (direct current) motor is generally utilized for an electrical vehicle motorization. The DC motor is driven by a controller which is powered by a battery accompanying the electrical vehicle. The controller includes a driver and a pulse width modulator. The driver is controlled by a governor to adjust and change a voltage outputting frequency to drive the DC motor. Also in accordance with an input voltage and current to a rotor coil of the motor, a torque and speed of the motor are controlled. Meanwhile, a Hall sensor installed in the DC motor senses a Hall signal for feedback to the pulse width modulator to generate a PWM signal entering to the driver to modulate the drive voltage. As such, the DC motor is capable of outputting a smooth and steady torque as well as having a precisely rotating speed control.

Conventional PWM technique uses a pulse width to modulate the output. That is, a continuous analog signal wave is monitored within a predetermined frequency (such as 60 times per second). The sampling values are correspondingly transmitted to a receiver for regenerating the original analog signal under a negative feedback system. For use in the motor of the electrical vehicle, an outputting voltage of the driver is adjusted. As shown in FIG. 5, when a pulse 411 of the PWM signal 410 increases gradually, the regenerated voltage 211 of the signal 210 will be higher and higher. Alternatively, as shown in FIG. 6, if the pulse 411 reduces gradually, decreasing voltage 211 will be obtained. The width of the pulse 411 is controlled by calculating the signal 210 with the Hall signal of the negative feedback. As such, PWM technique provides the advantage of optimizing energy transmitting to enhance the usage of the battery.

The reason PWM technique can provides the power-saving benefit is because it corrects the expected lower outputting drive voltage due to transmitting loss to a higher voltage more match to the actual rotating speed of the motor. However, as PWM signal alternatively reduces an increasing voltage to meet the more precise voltage needed by the motor, the performance of the electrical vehicle is inevitably affected. At this time, the accuracy is not mostly concerned to the electrical vehicle; therefore, the implemented modulation merely wastes power of the battery of the electrical vehicle.

### SUMMARY OF THE INVENTION

The present invention is to provide a motor control apparatus for a motor of an electrical vehicle which merely depends on a reducing rotating speed of a motor to control a PWM signal to increase a drive voltage of the motor.

The motor control apparatus of the present invention includes a driver, a governor, a PWM device, a Hall sensor and an energy saver. The driver sends a driving signal to a motor of the electrical vehicle. The governor is controlled by a user to output a speed adjusting signal to the driver so that the driver can drive the motor to change a rotating speed. The PWM device is connected to the driver. The Hall sensor is installed in the motor for detecting a speed change of the motor to send a Hall signal to the PWM device. The energy saver is connected with driver for detecting a change of the driving signal to control the PWM device to send a PWM signal to the driver merely as the rotating speed of the motor is reduced.

### BRIEF DESCRIPTION OF THE DRAWINGS

The present invention will become more fully understood from the detailed description given hereinbelow illustration only, and thus are not limitative of the present invention, and wherein:

FIG. 1 shows a block diagram of a voltage modulating apparatus according to the present invention;

FIG. 2 is a diagram of the rotating speed of the motor;

FIG. 3 is an enlarged view of section a in FIG. 2;

FIG. 4 is an enlarged view of section b in FIG. 2; and

FIGS. 5 and 6 show the results of performing conventional PWM technique.

### DETAILED DESCRIPTION OF THE INVENTION

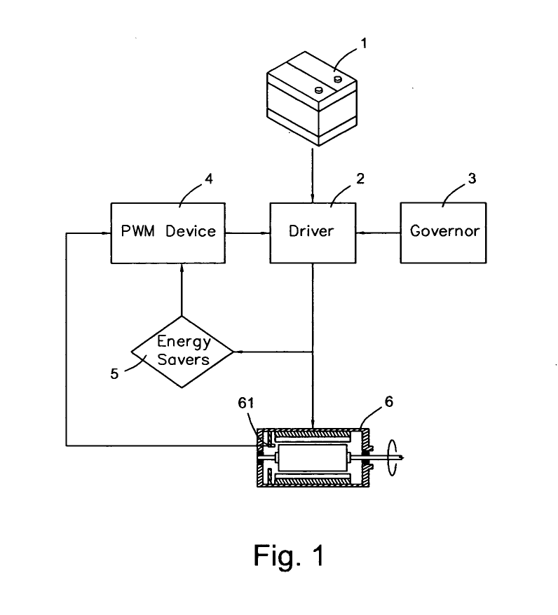

Please refer to FIG. 1. The present invention provides a voltage modulating apparatus for a motor of an electrical vehicle, which includes a driver 2, a governor 3, a PWM device 4, an energy saver 5 and a Hall sensor 61. A battery 1 installed in the vehicle is connected to the driver 2. The driver 2 is connected to the energy saver 5 and a DC motor 6. The energy saver 5 is connected to the PWM device 4. The governor 3 and the PWM device 4 are connected to the driver 2. The Hall sensor 61 installed in the DC motor 6 is connected to the PWM device 4.

The battery 1 provides DC voltage power to start the driver 2 and other circuits. The governor 3 is controlled by the user to output a speed adjusting signal to the driver 2. The driver 2 thus drives the DC motor 6 to change the rotating speed. Meanwhile, the Hall sensor 61 detects the speed change of the DC motor 6 to send a Hall signal to the PWM device 4, and the energy saver 5 control the PWM device 4 to decide whether a PWM signal is sent from the PWM device 4 to the driver 2 depending on the output from the driver 2 to the DC motor 6. The details are described as follows.

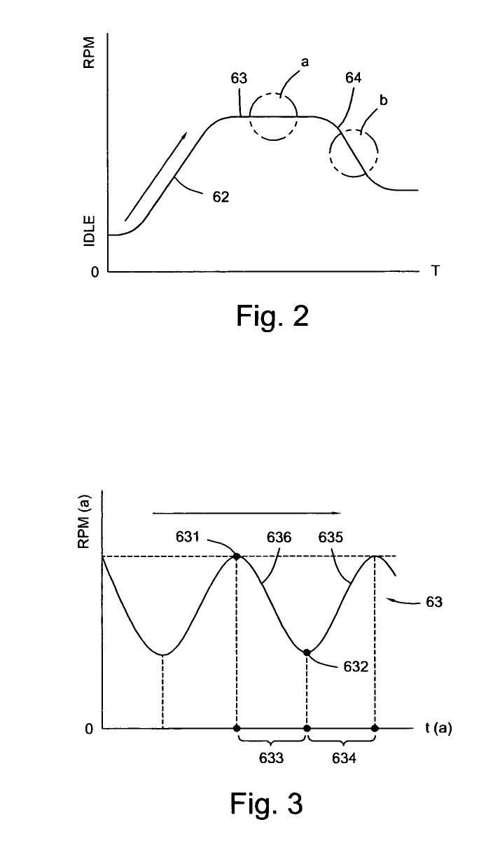

Referring to FIG. 2, when the user speeds up the electrical vehicle, the speed adjusting signal will be a speed increasing signal sent to the driver 2. The driver 2 accordingly outputs an increasing drive voltage to the DC motor 6 so that the DC motor 6 can generate an increasing rotating speed 62. The Hall sensor 61 detects the increasing speed of DC motor 6 to send a Hall signal to the PWM device 4. The energy saver 5 detects a current change due to the increasing drive voltage to know the rotating speed of the DC motor 6 is increasing so that the energy saver 5 will control the PWM device 4 not to output the PWM signal to the DC motor 6. That is, no modulation will be performed on the DC motor 6.

Further referring to FIG. 3, on the other hand when the driver 2 outputs a constant drive voltage to the DC motor 6, ideally the DC motor 6 will rotate at a constant speed 63. Similarly, the Hall sensor 61 detects the constant speed of the DC motor 6 to send the Hall signal to the PWM device 4. The energy saver 5 detects no current change due to the constant drive voltage to know the rotating speed of the DC motor 6 is constant so that the energy saver 5 will also control the PWM device 4 not to output the PWM signal to the DC motor 6. However, the constant drive voltage will be decreasing because of the transmitting loss. The energy saver 5 thus will in fact detect the current change due to the decreasing drive voltage to know the reducing rotating speed of the DC motor 6 to send an activating signal to the PWM device 4 at the maximum point 631 as the rotating speed is going down. The PWM device 4 is then controlled by the activating signal to send the PWM signal to the driver 2. The pulse width of the PWM signal is changed according to the Hall signal to increase the drive voltage outputted from the driver 2. As such, the rotating speed of the DC motor 6 will be increased. Furthermore, the energy saver 5 continuously detects the reducing rotating speed of the DC motor 6 until the rotating speed is going up at the minimum point 632 so as to stop sending the activating signal to the PWM device 4. Therefore, the action of the PWM device 4 is controlled within a descent period 633, and the rotating speed of the DC motor 6 will oscillate during the periodic descent period 633 and ascent period 634. Moreover, the descent rate 636 of the rotating speed is similar to the ascent rate 635, such that a power saving effect can be obtained.

Table 1 shows the performance of the present invention compared to two conventional types of electrical vehicles. In result, the electrical vehicle of present invention with the voltage modulating apparatus is much better at navigation.

TABLE 1

| | Items | | | |
|---|---|---|---|---|
| | | | Weight | |
| Vehicles | Speed (km/hr) | Navigation (km) | (kg) | Power |
| Conventional | 30 | 65 | 95 | DC battery |
| City Bike | | | | |
| Conventional | 30 | 60 | 105 | DC battery |
| “EC1” | | | | |
| Present | 30 | 125.4 | 130 | DC battery |
| Invention | | | | |

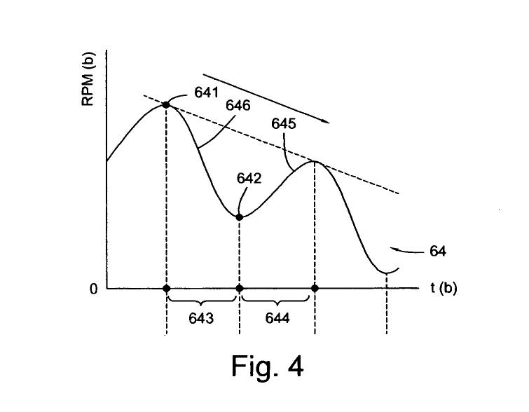

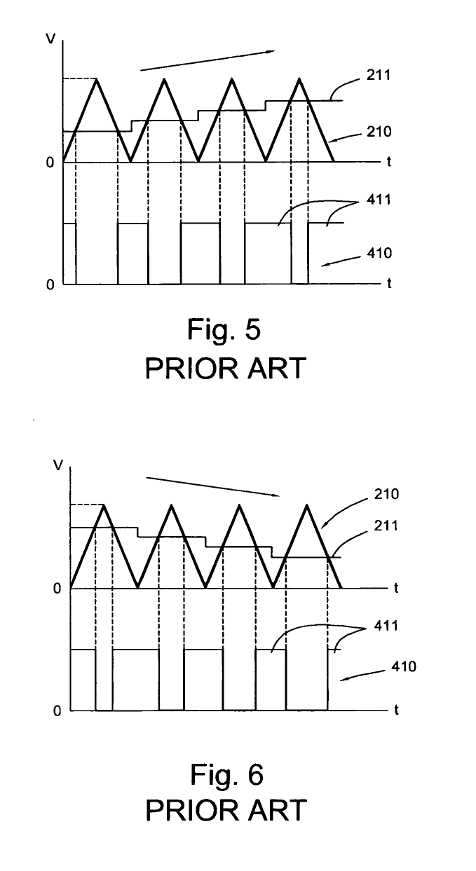

Together referring to FIGS. 2 and 4, when the governor 3 outputs a speed decreasing signal to the driver 2, the driver 2 will input a decreasing drive voltage to drive the DC motor 6 to generate a reducing rotating speed 64. Similarly, the Hall sensor 61 detects the decreasing speed of the DC motor 6 to send the Hall signal to the PWM device 4. The energy saver 5 detects the current change due to the decreasing drive voltage to know the reducing rotating speed of the DC motor 6 to send the activating signal to the PWM device 4 at the maximum point 641 as the rotating speed is going down. The PWM device 4 is then controlled by the activating signal to send the PWM signal to the driver 2. The pulse width of the PWM signal is changed according to the Hall signal to increase the drive voltage outputted from the driver 2. As such, the rotating speed of the DC motor 6 will be increased. Furthermore, the energy saver 5 continuously detects the increasing rotating speed of the DC motor 6 to stop the activating signal sent to the PWM device 4 at the minimum point 642 as the rotating speed is going up. Therefore, the action of the PWM device 4 is controlled within a descent period 643, and the rotating speed of the DC motor 6 will oscillate during the periodic descent period 643 and ascent period 644. Moreover, the descent rate 646 of the rotating speed is larger than the ascent rate 645, such that the power saving effect is obtained.

The invention being thus described, it will be obvious that the same may be varied in many ways. As such, the energy saver 5 can detect a voltage or current change of the motor to decide the activation of the PWM device 4. Such variations are not to be regarded as a departure from the spirit and scope of the invention, and all such modifications as would be obvious to one skilled in the art are intended to be included within the scope of the following claims.

What is claimed is:

1. A motor control apparatus for an electrical vehicle, comprising:
a driver for sending a driving signal to a motor of the electrical vehicle;
a governor controlled by a user to output a speed adjusting signal to the driver so that the driver can drive the motor to change a rotating speed;
a pulse width modulation (PWM) device connected to the driver;
a Hall sensor installed in the motor for detecting a speed change of the motor to send a Hall signal to the PWM device; and
an energy saver connected with driver, for detecting a change of the driving signal to control the PWM device to send a PWM signal to the driver merely as the rotating speed of the motor is reduced.

2. The apparatus of claim 1, wherein the driving signal is a voltage driving signal.

3. The apparatus of claim 2, wherein the energy saver detects a current change of a decreasing voltage driving signal to control the PWM device to send the PWM signal to the driver.

4. The apparatus of claim 2, wherein the energy saver detects a current change of a increasing voltage driving signal to control the PWM device not to send the PWM signal to the driver.

5. The apparatus of claim 2, wherein the energy saver detects a current change of a constant voltage driving signal to control the PWM device not to send the PWM signal to the driver.
